(19) United States
(12) Patent Application Publication
(10) Pub. No.: US 2002/0048498 A1
(43) Pub. Date: Apr. 25, 2002

(54) Nut plug assembly for structural poles

(75) Inventor: L. Ronald Bartels, Bay City, WI (US)

Correspondence Address: Salvatore J. Abbruzzese, Esq., HOFFMANN & BARON, LLP, 6900 Jericho Turnpike, Syosset, NY, 11791, US

(73) Assignee: Thomas & Betts International, Inc.

(21) Appl. No.: 09/982,149

(22) Filed: Oct. 18, 2001

Related U.S. Application Data
(60) Provisional application No. 60/242,818, filed on Oct. 24, 2000.

(51) Int. Cl. F16B 37/06

(52) U.S. Cl. 411/171

(57) ABSTRACT

A nut plug assembly for use with structural poles includes a nut, bolt and washer attached to a nut secured to the pole. The plug assembly remains within the pole nut throughout the galvanizing process and would be readily removed by the user just prior to having a need to use the pole nut for attachment of an accessory structure. As the nut plug assembly would remain in the nut after the galvanizing process, rust appearance would be minimized as the threads of the nut would not be exposed. It is only upon the user needing access to that particular nut that the plug assembly would be removed and an accessory component would be immediately inserted into the desired nut.

### FIELD OF THE INVENTION

The present invention relates generally to a nut plug assembly for use with structural poles such as steel poles. More particularly, the present invention relates to a plug assembly for protecting the threads of a nut welded to a galvanized steel pole.

### BACKGROUND OF THE INVENTION

In the past it has been known to use steel structures, such as steel poles, to support electrical wires and cables outdoors. In order to protect the pole from the adverse effects of the outdoor environment, these poles are typically galvanized with a zinc coating. The zinc coating affords ample corrosion protection to the pole, inhibiting rusting of the metal.

Quite often, it is necessary to weld attachment devices such as nuts to the outside of the pole along the length thereof. These nuts may be used to attach certain secondary structures to the pole such as climbing steps or jacking devices.

The welding of nuts to the pole presents certain problems. As the nuts are typically welded to the pole prior to the galvanizing process, the nuts, particularly the internal threads of the nuts, are subject to being coated by the zinc used to coat the poles. In order to render the threads of the nuts accessible and usable, these nuts must be retapped to establish the internal threads. This results in the threads being unprotected as the zinc is removed therefrom. This increases the risk that the internal threads of the nut will rust upon exposure to the outdoor elements.

One potential solution to this problem is to insert a bolt into the welded nut prior to galvanizing the pole. The bolt would protect the thread of the nuts during the galvanizing process. However, it has been found that, if the bolt is left in the nut during the galvanizing process, the bolt comes soldered or “frozen” to the nut, rendering it nearly impossible to remove the bolt from the nut. Attempts to remove the bolt from the nut after the galvanizing process results in the bolt severing before it can be properly removed from the nut.

Attempts have also been made in the past to remove the bolt immediately after application of the zinc coating so that the bolts were removed while the zinc was still hot to assure that the bolts were not soldered to the nut. While this served to permit the bolts to be removed from the nuts, it still resulted in the threads being uncoated and, therefore, failed to minimize the rust occurrence at the uncoated threads.

Thus, there is a need for a nut plug assembly which may remain in the nut welded to the pole during the entire galvanizing process, and which can be easily removed from the nut by the user to render the nut accessible for attachment of accessory components at a time subsequent to the galvanizing process.

### SUMMARY OF THE INVENTION

The present invention provides a plug assembly, which is inserted into a nut welded to a structural pole so that it remains within the nut throughout the galvanizing process. It is contemplated that, by the construction of the plug assembly of the present invention, the plug assembly would remain within the nut and would be readily removed by the user just prior to having a need to use the nut for attachment of an accessory structure. As the plug would remain in the nut after the galvanizing process, rust appearance would be minimized, as the threads of the nut would not be exposed. It is only upon the user needing access to that particular nut that the plug assembly would be removed and an accessory component would be immediately inserted into the desired nut.

The present invention further contemplates a plug assembly for protecting the threads of a nut welded to a galvanized pole. First, the high temperature lubricant is coated on the threads of the nut, making it possible to remove the nut plug at any time after galvanizing without fear of the plug being soldered (frozen) into the nut. Second, the high temperature resistant washer in the nut plug assembly prevents the pickling acid, process required prior to hot dip galvanizing from removing the high temperature lubricant. Third, the high temperature resistant washer survives the high temperature galvanizing kettle and subsequently seals the assembly before disassembly and after assembly to minimize rust bleeding from the mating threads.

### BRIEF DESCRIPTION OF DRAWINGS

FIGS. 1 and 2 are side and top plan views of a portion of a steel pole, including a plurality of nuts welded thereto along the length thereof.

FIG. 3 is an exploded view of a nut plug assembly of the present invention inserted into a nut welded to a structural pole.

FIG. 4 is an assembled view of the nut plug assembly of FIG. 2.

FIG. 5 is a side plan view of various nut plug assemblies of the present invention attached to a structural pole.

### DETAILED DESCRIPTION OF THE PREFERRED EMBODIMENT

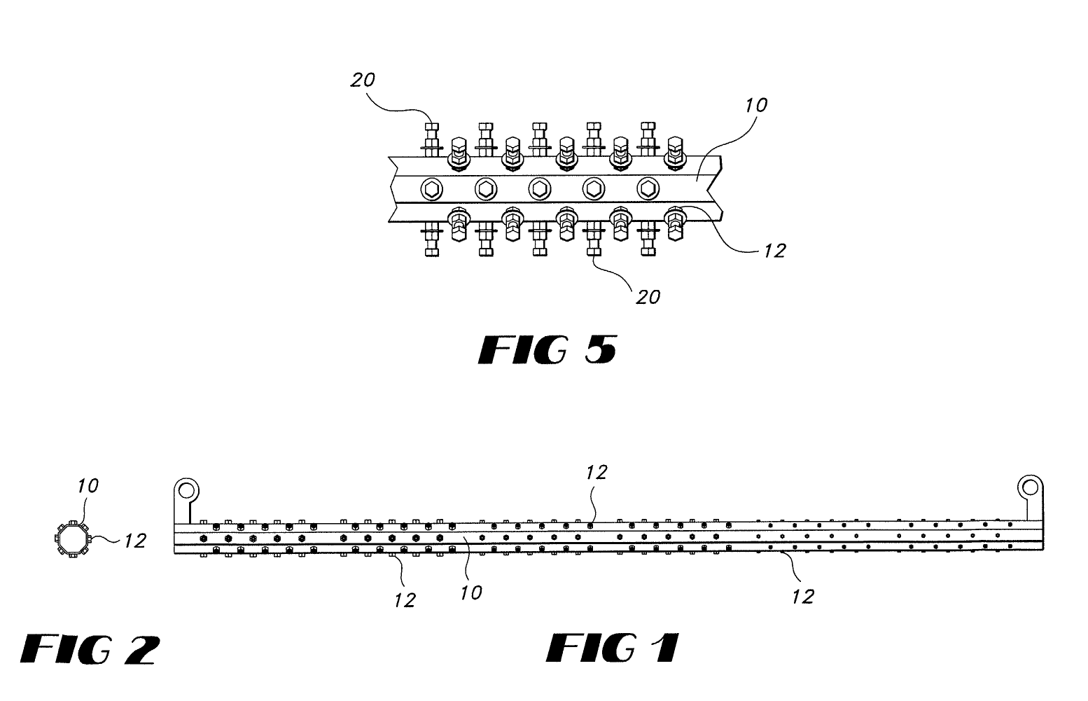

Referring to FIGS. 1 and 2, a section of pole 10 is shown having a plurality of pole nuts 12 welded thereto in a conventional fashion. As mentioned above, the nuts 12 may be employed to provide for the attachment of secondary structures to the pole 10, such as a step, a grounding member or device (not shown) used for jacking purposes.

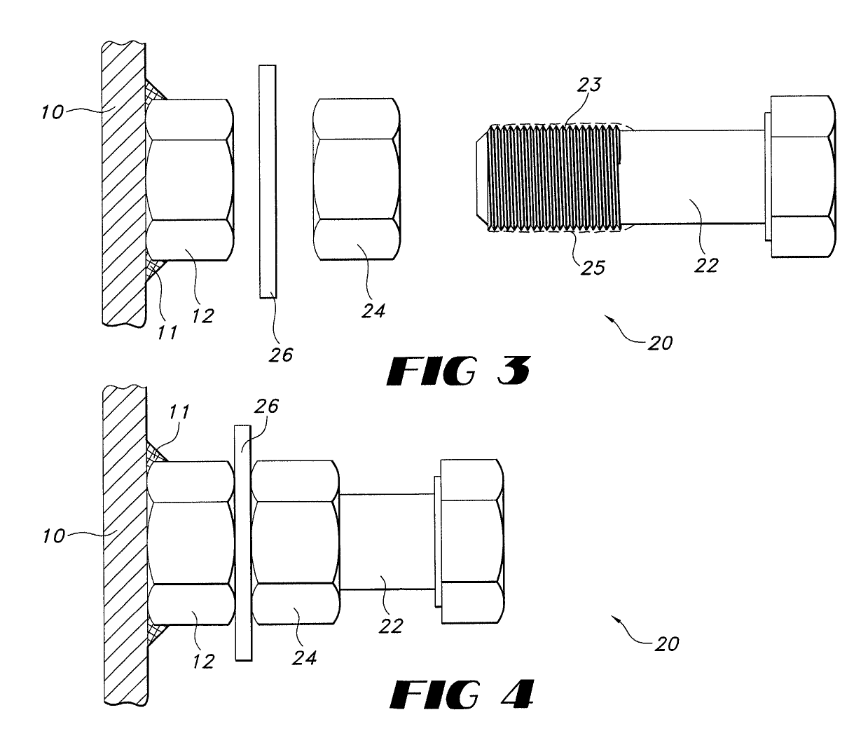

As shown in FIG. 1, the nuts 12 are attached on the pole 10 in various configurations and arrangements along the length thereof. The nuts 12 are typically welded to the pole 10 at weldments 11 shown in FIGS. 3 and 4. FIG. 1 shows various types of nuts 12, which may be employed in combination to the pole 10.

FIG. 2 merely illustrates a top view of the portion of the pole 10 with a plurality of nuts 12 welded to the pole 10.

In order to maintain the integrity of the internal threads of the nuts 12 attached to pole 10, the present invention provides a nut plug assembly 20 shown in FIGS. 3 and 4. FIG. 3 shows a nut plug 20 unassembled with various parts as will be discussed below, whereas in FIG. 4, the nut plug 20 is shown assembled. The nut plug assembly includes a standard hexhead bolt 22, a securement nut 24 and a resilient washer 26. In order to assure the removability of the bolt 22 from nut 12 attached to pole 10, the threads 23 of bolt 22 are coated with a high temperature lubricant 25. Certain lubricants which may be employed in combination with the washer. These lubricants include graphite lubricant, molybdenum disulfide lubricant and PTFE (Teflon) lubricant. Other lubricants known in the art could also be employed. As mentioned above, the nut plug assembly 20, which is inserted into nut 12, must withstand the temperatures of hot dip galvanizing in molten zinc. Accordingly, the lubricants employed must be high temperature lubricants able to withstand the high temperatures of the molten zinc. The above-noted lubricants are useful for such purposes. However, it is apparent that there exists other high temperature lubricants which may be employed in combination with the present invention.

As is conventionally known, the galvanizing process employed is hot dip galvanizing. Hot dip galvanizing is achieved by dipping the pole into a kettle containing molten zinc approaching 850° F. Prior to dipping the pole into the molten zinc, the pole is subjected to a pickling process. The pickling process involves applying an acid wash to the pole to help assure the complete coating of the pole with the zinc. After acid pickling, the pole would be water rinsed just prior to galvanizing. As noted above, the pickling process is an acid wash, which is used to clean the surface of the pole to enable the zinc galvanizing material to adequately adhere to the pole. It is contemplated that the acid from the pickling process, prior to galvanizing the pole, may have a tendency to remove the high temperature lubricant 25 around the threads 23 at the juncture of the bolt 22 and nut 12. In order to prevent the acid from removing the high temperature lubricant 25, and thereby making it more difficult to remove the bolt 22 from the nut 12 after galvanizing, the present invention contemplates employing a resilient annular washer 26 about nut 12. As shown in FIG. 4, the resilient washer 26 is secured about bolt 22 and to nut 12 by a securement nut 24 to tighten down around bolt 22. This affixes the washer 26 therebetween. Washer 26 is formed of suitably resilient material, which is resistant to both the acid of the pickling process and the high temperatures of the galvanizing coating. While various polymers may be used to form washer 26, one material which has been particularly beneficial in forming washer 26 is polytetrafluoroethylene (PTFE) sold under the trademark “Teflon”. PTFE is selected as a preferred material for the washer and is high temperature resistant, able to withstand the temperatures of the hot dip galvanizing bath. Furthermore, PTFE is acid resistant and, therefore, can withstand the pickling process. The washer 26 is held between nut 12 and securement nut 24 so as to seal the threads of nut 12 about bolt 22, preventing the acid from entering the nut 12 and contacting the threads 23, thereof which could result in removal of the high temperature lubricant, making removal of the bolt difficult.

This nut plug assembly 20 is left in the welded nut 12 through all subsequent operations such as shot blasting, acid pickling, water rinses, galvanizing and shipping to the customer.

The customer removes the nut plug assembly 20 at the time he is to use the welded nut 12 for its intended purpose. If the threads 23 of the welded nut 12 become exposed to the elements once the customer has finished using the welded nut 12 for its intended purpose, the original nut plug assembly 20 is to be reinserted into the welded nut 12 and tightened securely.

No rust bleeding will occur from nut plug assemblies that have not been disassembled. Rust bleeding is very unlikely to occur if some other galvanized bolt such as a step bolt, grounding bolt, etc., replaces the nut plug assembly. Rust bleeding is unlikely to occur if the nut plug assembly is reinserted into the welded nut after the welded nut has been used for its intended purpose, for example, jacking nuts.

An example of a nut plug assembly of the present invention and its installation on a nut welded to a pole is set forth hereinbelow.

Tests have verified that the optimum way to overcome the rust-bleeding problem with respect to welded nuts is to plug the nut with an assembly composed of:

1. A SAE Grade #2 bolt coated with graphite.

2. A Teflon washer.

3. A SAE Grade #2 nut.

The bolt is screwed into the welded nut with the Teflon washer between the welded nut and the grade #2 nut. The grade #2 nut is tightened securely (approximately 30-50% of yield strength) against the welded nut manually. This assembly operation is performed during the fabrication of the pole.

The Teflon washer serves two purposes. First, it prevents pickling acid from removing lubricant from the mating threads of the welded nut and the nut plug assembly. This insures that the nut plug assembly can be removed from the welded nut with ordinary wrenches at any time. The Teflon washer withstands the high temperatures of the galvanizing kettle sufficiently well that it seals the mating threads from the elements. When the nut plug assembly is reassembled into the welded nut, the Teflon washer seals the mating threads from the elements. This second benefit of sealing the mating threads minimizes the potential for rust bleeding.

FIG. 5 illustrates typical structure of several nut plug assemblies 20 on a nut 12 welded to the pole 10. The nut plug assemblies 20 shown are of various combinations and configurations of lubricated bolts with washers and nuts for all different types and sizes are employed. For examples, Teflon lubricant in combination with nylon washer and nut and bolt, graphite lubricant with nut and bolt, molybdenum disulfide lubricant and bolt, bare bolt, etc.

While the invention has been described by the foregoing detailed description in relation to the preferred embodiments with several examples, it will be understood by those skilled in the art that various changes may be made without deviating from the spirit and scope of the invention as defined in the appended claims.

What is claimed is:

1. A nut plug assembly for securement to a pole, comprising:
an elongate bolt having an externally threaded end;
a temperature resistant lubricant applied to said threads of said bolt;
an internally threaded pole nut attached to said pole and threadingly accommodating said bolt; and
a washer interposed between said bolt and said pole nut for protecting said lubricant on said threads from an acid wash applied to said pole.

2. The nut plug assembly of claim 1 further including a securement bolt interposed between said bolt and said washer for sealingly securing said washer.

3. The nut plug assembly of claim 1, wherein said pole nut is welded to said pole.

4. The nut plug assembly of claim 1, wherein the washer is formed of a resilient material for sealing the threads of the bolt.

5. The nut plug assembly of claim 1, wherein the washer is acid resistant for resisting said acid wash applied to the pole.

6. The nut plug assembly of claim 1, wherein the washer is a temperature resistant for withstanding temperature of hot dip galvanizing of the pole.

7. A method of preventing rusting of threaded portion of a nut attached to a pole, comprising the steps of:
coating a lubricant on the threaded portion of a bolt;
placing an annular washer between the nut and the bolt;
threadly attaching the bolt to the nut;
applying an acid wash to the pole;
galvanizing the pole by coating the pole with zinc.

8. The method of claim 7, further comprising the steps of:
interposing a securement nut between said washer and said nut for securing said washer to said nut.

9. The method of claim 7, wherein said coating step includes applying a high temperature-resistant lubricant to said bolt.

10. The method of claim 7, wherein said galvanizing step includes coating said pole with zinc at a high temperature.

11. The method of claim 7, wherein the annular washer is formed of a resilient material for sealing the threads of the nut.

12. The method of claim 7, wherein the annular washer is acid resistant for resisting acid wash of the pole.
